(19) United States
(12) Patent Application Publication
(10) Pub. No.: US 2025/0245047 A1
(43) Pub. Date: Jul. 31, 2025

(54) METHOD AND APPARATUS FOR SCHEDULING TIME SLICE

(71) Applicant: Jingdong Technology Information Technology Co., Ltd., Beijing (CN)

(72) Inventor: Sixing XIAO, Beijing (CN)

(21) Appl. No.: 18/942,187

(22) Filed: Nov. 8, 2024

(30) Foreign Application Priority Data
Jan. 29, 2024 (CN) 202410121566.3

(51) Int. Cl. G06F 9/50

(52) U.S. Cl. CPC G06F 9/5027

(57) ABSTRACT

A method and apparatus for scheduling a time slice, and relates to the technical field of resource scheduling. A specific embodiment of the method includes: determining a scheduling period based on the number of virtual cards in a virtual card set and a maximum scheduling delay; determining, based on the scheduling period, time slices corresponding to virtual cards in the virtual card set; and performing a scheduling operation on the virtual card set, the scheduling operation including: ending the scheduling period, in response to determining that in the virtual card set there is no designated virtual card having a non-empty load and no corresponding time slice allocated.

### CROSS-REFERENCE TO RELATED APPLICATIONS

This application claims the benefit of and priority to Chinese Patent Application No. 202410121566.3, filed with the Chinese Patent Office (CNIPA) on Jan. 29, 2024, which is hereby incorporated by reference herein in its entirety.

### TECHNICAL FIELD

The present disclosure relates to the field of computer technology, in particular to the field of resource scheduling technology, and more particularly, to a method and apparatus for scheduling a time slice.

### BACKGROUND

An external accelerator card such as GPU (Graphics Processing Unit) is powerful and is an expensive computing resource that needs to be shared among multiple applications, containers, or virtual machines in order to be fully utilised. Sharing technology may usually be divided into two types: null division and time division. Null division performs strict slicing on resources within the card, guaranteeing strong isolation of jobs using a virtual card when using the resources; time division technology simply uses time-division multiplexing to achieve multiple virtual cards using an arithmetic resource of the card according to allocated time slices; after allocating the time slices to the virtual cards, jobs on the virtual cards are all activated to use the accelerator card resource. When the time slices run out, the computing resource is conceded.

The allocation of time slices tends to be static due to random timing of upper tier applications using the accelerator card such as GPU. Within a scheduling period, after allocating time slices to virtual cards, when the time slices run out, switch to a new virtual card so that jobs on the new virtual card may use the accelerator card for computation. If a load of the jobs on the virtual card is less than a provided arithmetic power within the allocated time slice, it may result in some of the arithmetic power being idle, thus resulting in a waste of the arithmetic resource of the accelerator card.

### SUMMARY

Embodiments of the present disclosure provide a method and apparatus for scheduling a time slice, a device, and a storage medium.

According to a first aspect, an embodiment of the present disclosure provides a method for scheduling a time slice. The method includes: determining a scheduling period based on the number of virtual cards in a virtual card set and a maximum scheduling delay; determining, based on the scheduling period, time slices corresponding to the virtual cards in the virtual card set; and performing a scheduling operation on the virtual card set.

According to a second aspect, an embodiment of the present disclosure provides an apparatus for scheduling a time slice, the apparatus including: a generation module, configured to determine a scheduling period based on the number of virtual cards in a virtual card set and a maximum scheduling delay; a determination module, configured to determine, based on the scheduling period, time slices corresponding to the virtual cards in the virtual card set; and a scheduling module, configured to perform a scheduling operation on the virtual card set.

According to a third aspect, an embodiment of the present disclosure provides an electronic device. The electronic device includes one or more processors, and a memory storing one or more programs. The one or more programs when executed by one or more processors, cause the one or more processors to implement the method for scheduling a time slice according to any embodiment in the first aspect.

According to a fourth aspect, an embodiment of the present disclosure provides a computer readable medium, storing a computer program. When the program is executed by a processor, the method for scheduling a time slice according to any embodiment in the first aspect is implemented.

It should be understood that the content described in this section is not intended to identify critical or important features of embodiments of the present disclosure, and is not used to limit the scope of the present disclosure. Other features of the present disclosure will become readily comprehensible through the following description.

### BRIEF DESCRIPTION OF THE DRAWINGS

FIG. 1 is a flowchart of a method for scheduling a time slice according to an embodiment of the present disclosure;

FIG. 2 is a timing diagram of the method for scheduling a time slice according to an embodiment of the present disclosure;

FIG. 3 is a flowchart of the method for scheduling a time slice according to an embodiment of the present disclosure;

FIG. 4 is a flowchart of an apparatus for scheduling a time slice according to an embodiment of the present disclosure; and

FIG. 5 is a schematic structural diagram of a computer system suitable for implementing a server of embodiments of the present disclosure.

### DETAILED DESCRIPTION OF EMBODIMENTS

Example embodiments of the present disclosure are described below with reference to the accompanying drawings, where various details of embodiments of the present disclosure are included to facilitate understanding, and should be considered merely as examples. Therefore, those of ordinary skills in the art should realize that various changes and modifications may be made to embodiments described herein without departing from the scope and spirit of the present disclosure. Similarly, for clearness and conciseness, descriptions of well-known functions and structures are omitted in the following description.

It should be noted that embodiments of the present disclosure and the features described therein may be combined with each other on a non-conflict basis. Embodiments of the present disclosure are described below with reference to the accompanying drawings.

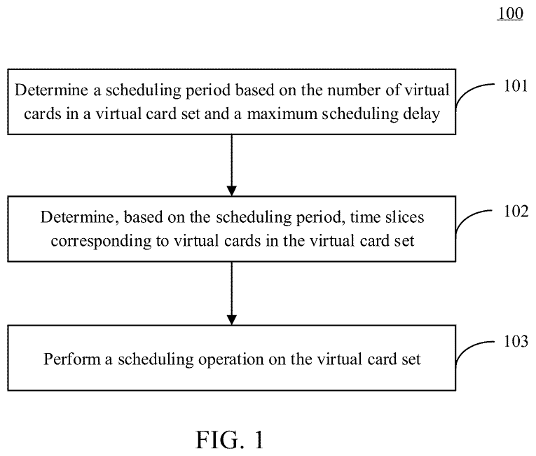

FIG. 1 illustrates a flow 100 of a method for scheduling a time slice that can be applied to an embodiment of the present disclosure. In the present embodiment, the method for scheduling a time slice is applied in a processor, and the method for scheduling a time slice includes the following steps.

Step 101, determining a scheduling period based on the number of virtual cards in a virtual card set and a maximum scheduling delay.

In the present embodiment, an executing body (e.g., a processor) may allocate, via a computing power scheduler, a scheduler thread to each external processor (e.g., an accelerator card, a graphics card, a compute card, etc.) that provides computing power resources, and calculates the scheduling period via the scheduler thread.

Here, the scheduling period may be obtained by calculating a product of the number of virtual cards in the virtual card set and the maximum scheduling delay.

In particular, the scheduling period T may be expressed by the following equation:
Scheduling period T=number of virtual cards*maximum scheduling delay.

Here, the virtual card has a task queue that waits to use an external computing power resource, such as a FIFO task queue, the task queue represents a load.

Here, the task queue waiting to use the external computing power resource may be generated based on tasks submitted by an application via a native API, typically, one application corresponds to one or more virtual cards.

Step 102, determining, based on the scheduling period, time slices corresponding to virtual cards in the virtual card set.

In the present embodiment, after determining the scheduling period, the executing body may directly determine the time slices corresponding to the respective virtual cards, based on the number of virtual cards; or may determine the time slices corresponding to the respective virtual cards, based on the weights of the respective virtual cards in the virtual card set; or may first determine whether there is a high-priority virtual card (i.e., a preset virtual card of high-priority) in the virtual card set, if yes, then preferentially allocate the scheduling period to the high-priority virtual card, until a length of the task queue in the high-priority virtual card is zero, and then, based on remaining time slice(s) in the scheduling period, determine time slices corresponding to virtual cards in remaining virtual cards in the virtual card set other than the high-priority virtual card, which is not limited in the present disclosure.

Here, a time slice is used to indicate a duration of using an external computing power resource by a virtual card, such as a duration of using the computing power resource provided by an external accelerator card.

In particular, the scheduling period is T, in the virtual card set, the time slice corresponding to a virtual card may be expressed by the following equation:

Time slice corresponding to a virtual card=(weight of the virtual card/sum of weights of the virtual cards)*T

Step 103, performing a scheduling operation on the virtual card set.

In the present embodiment, after determining the time slices corresponding to the respective virtual cards, the executing body may perform the following scheduling operation: detecting in real time or periodically whether there is a designated virtual card having a non-empty load and no time slice allocated in the virtual card set, if not, early ending the scheduling period, or if there has been always no virtual card having a non-empty load and no time slice allocated in the virtual card set, then allocating no corresponding time slice, to avoid waste of the computing power resource of the accelerator card.

In some alterative implementations, the scheduling operation further includes: in response to determining that in the virtual card set there is designated virtual card(s) having a non-empty load and no corresponding time slice allocated, determining a target virtual card in the designated virtual card(s) and allocating a corresponding time slice to the target virtual card; and before the time slice corresponding to the target virtual card runs out, continuing to perform the scheduling operation in response to determining that a load of the target virtual card is empty.

In this implementation, the executing body may detect, in real time or periodically, whether in the virtual card set there is designated virtual card(s) having a non-empty load (i.e., the length of the task queue is non-zero) and no corresponding time slice allocated, if yes, determine the target virtual card in the designated virtual card(s), and allocate a corresponding time slice to the target virtual card. That is, within the duration indicated by the time slice, tasks on the task queue of the target virtual card are submitted to an execution queue of the external accelerator card connected to the processor for execution; before the time slice corresponding to the target virtual card runs out, if the load of the target virtual card is detected to be empty (i.e., the length of the task queue is zero), continue to perform the scheduling operation.

Here, the manner according to which the executing body determines whether in the virtual card set there is a designated virtual card having a non-empty load and no corresponding time slice allocated, may be to directly acquire states of all virtual cards in the virtual card set to determine whether there is a designated virtual card having a non-empty load and no time slice allocated, or to sequentially traverse the virtual cards in the virtual card set that has no corresponding time slice allocated, to determine whether there is a designated virtual card having a non-empty load, which is not limited in the present disclosure.

In particular, after determining the time slices corresponding to the respective virtual cards, the executing body may sequentially traverse the virtual cards that have no corresponding time slice allocated in the virtual card set, if there is a virtual card having a non-empty load, determine the virtual card as a designated virtual card, as well as directly determine the designated virtual card as the target virtual card and allocate a corresponding time slice thereto. For example, for a current virtual card that has no time slice allocated, determine whether the load of the current virtual card is empty, if the load is empty, select and switch to a next virtual card, i.e., determine the next virtual card as the current virtual card, to further determine whether the load of the current virtual card is empty, if the load is not empty, determine the current virtual card as the target virtual card and allocate the corresponding time slice thereto.

Further, before the time slice corresponding to the target virtual card runs out, the load of the target virtual card is detected in real time or periodically to determine whether it is empty, if the load is empty, continue to perform the scheduling operation.

The implementation helps to early end the scheduling period and effectively avoids waste of computing power resources, by determining the target virtual card in the designated virtual card(s) and allocating a corresponding time slice thereto, in response to determining that there is the designated virtual card having a non-empty load and no corresponding time slice allocated in the virtual card set; and before the time slice corresponding to the target virtual card runs out, continuing to perform the above scheduling operation in response to determining that the load of the target virtual card is empty.

In some alternative implementations, the scheduling operation further includes: in response to determining that there is designated virtual card(s) having a non-empty load and no corresponding time slice(s) allocated in the virtual card set, determining a target virtual card in the designated virtual card(s) and allocating a corresponding time slice; and continuing to perform the scheduling operation in response to determining that the time slice corresponding to the target virtual card runs out.

In this implementation, the executing body may detect in real time or periodically, whether in the virtual card set there is designated virtual card(s) having a non-empty load and no corresponding time slice allocated, if yes, determine a target virtual card in the designated virtual card(s), and allocate a corresponding time slice to the target virtual card; and continue to perform the scheduling operation, in response to detecting that the time slice corresponding to the target virtual card runs out.

In particular, after determining the time slices corresponding to the respective virtual cards, the executing body may sequentially traverse the virtual cards that have no time slice allocated in the virtual card set, if there is a virtual card having a non-empty load, determine the virtual card as a designated virtual card, as well as determine the designated virtual card as the target virtual card and allocate a corresponding time slice thereto. For example, for a current virtual card that has no time slice allocated, determine whether the load of the current virtual card is empty, if the load is empty, select and switch to a next virtual card, i.e., determine the next virtual card as the current virtual card, to further determine whether the load of the current virtual card is empty, if the load is not empty, determine the current virtual card as the target virtual card and allocate a corresponding time slice thereto.

Further, the executing may continue to perform the scheduling operation, in response to detecting that the time slice corresponding to the target virtual card runs out.

This implementation effectively avoids waste of computing power resources, and improves the effectiveness of time-slice scheduling by determining, in response to determining that in the virtual card set there is designated virtual card(s) having a non-empty load and no corresponding time slice allocated, a target virtual card in the designated virtual card(s) and allocating a corresponding time slice thereto; and in response to determining that the time slice corresponding to the target virtual card runs out, continuing to perform the scheduling operation.

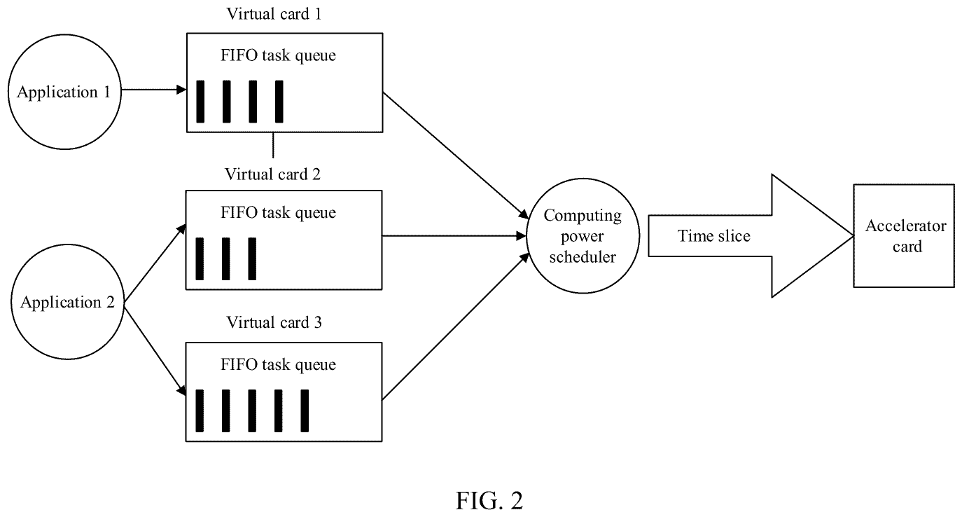

With further reference to FIG. 2, FIG. 2 is a diagram of an application scenario of the method for scheduling a time slice according to the present embodiment.

In the application scenario of FIG. 2, an executing body (e.g., GPU) may allocate a scheduler thread to each accelerator card via a computing power scheduler, and determine a scheduling period via the scheduler thread based on the number of virtual cards in a virtual card set and a maximum scheduling delay. The virtual card set may include virtual card 1, virtual card 2, and virtual card 3, where each virtual card has a task queue representing a load waiting to use the computing power resource of the accelerator card, such as FIFO task queue, and each virtual card corresponds to one or more applications, for example, the virtual card 1 corresponds to application 1, and the virtual card 2, the virtual card 3 correspond to application 2. Further, based on the scheduling period and weights of the virtual cards, the executing body determines a time slice corresponding to the virtual card in the virtual card set, i.e., a duration of using the accelerator card by the virtual card. Further, the executing body performs a scheduling operation on the virtual card set, the scheduling operation including: detecting, in real time or periodically, whether there is a designated virtual card having a non-empty load and no time slice allocated in the virtual card set, if no, early ending the scheduling period; if yes, determining a target virtual card in the designated virtual card(s) and allocating a corresponding time slice thereto, i.e., submitting tasks in the task queue of the target virtual card to an execution queue of an external accelerator card for execution; before the time slice corresponding to the target virtual card runs out, continuing to perform the scheduling operation in response to determining that a load of the target virtual card is empty; or, in response to determining that the time slice corresponding to the target virtual card runs out, continuing to perform the scheduling operation.

The method for scheduling a time slice in embodiments of the present disclosure, determines a scheduling period based on the number of virtual cards in a virtual card set and the maximum scheduling delay, determines time slices corresponding to virtual cards in the virtual card set based on the scheduling period, and performs a scheduling operation on the virtual card set, avoiding allocating a scheduled time slice of the accelerator card to a virtual card with empty load, reducing loss of task switching, avoiding waste of computing power resources, and improving the effectiveness of time-slice scheduling.

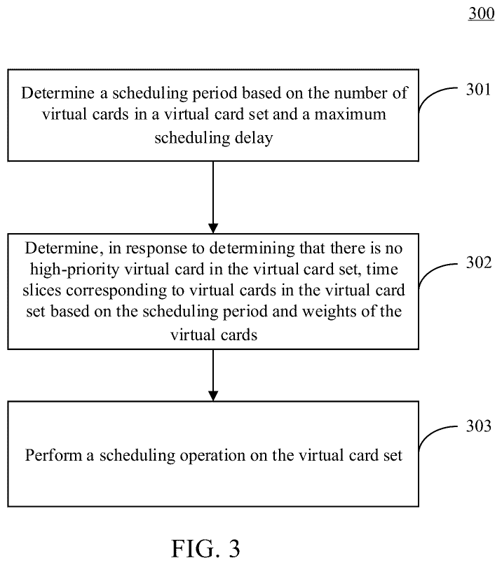

FIG. 3 shows a flow 300 of a method for scheduling a time slice that can be applied to another embodiment of the present disclosure. In the present embodiment, the method for scheduling a time slice includes the following steps.

Step 301, determining a scheduling period based on the number of virtual cards in a virtual card set and a maximum scheduling delay.

In the present embodiment, implementation details and technical effects of step 301 may be referred to the description of step 101, detailed description thereof will be omitted.

Step 302, in response to determining that there is no high-priority virtual card in the virtual card set, determining time slices corresponding to virtual cards in the virtual card set based on the scheduling period and weights of the virtual cards.

In the present embodiment, after determining the scheduling period, the executing body may first determine whether there is the high-priority virtual card, i.e., a preset virtual card of high priority, in the virtual card set, if no, the executing body may determine time slices corresponding to virtual cards based on the scheduling period and the weights of the virtual cards.

Here, the weights of the virtual cards may be set according to experience and actual needs, which is not limited in the present disclosure.

In some alternative implementations, the determining, based on the scheduling period, time slices corresponding to virtual cards in the virtual card set, includes: in response to determining that there is a high-priority virtual card in the virtual card set, allocating the scheduling period to the high-priority virtual card; in response to determining that a load of the high-priority virtual card is empty and that there is a remaining time slice in the scheduling period, determining, based on the remaining time slice and weights of virtual cards in a sub-virtual card set, time slices corresponding to the virtual cards in the sub-virtual card set.

In this implementation, after determining the scheduling period, the executing body may first determine whether there is the high-priority virtual card in the virtual card set, if yes, allocate the entire scheduling period to the high-priority virtual card until the load of the high-priority virtual card is empty, i.e., a length of the task queue is zero.

The executing body may, in response to determining that the load of the high-priority virtual card is empty and that there is the remaining time slice in the scheduling period, determine time slices corresponding to virtual cards in the sub-virtual card set, based on the remaining time slice and the weight of each virtual card in the sub-virtual card set.

Here, the sub-virtual card set is composed of non-high-priority virtual cards in the virtual card set, i.e., composed of virtual cards other than the high-priority virtual card in the virtual card set.

This implementation allocates the scheduling period to the high-priority virtual card, in response to determining that there is the high-priority virtual card in the virtual card set; in response to determining that the load of the high-priority virtual card is empty and that there is the remaining time slice in the scheduling period, determines time slices corresponding to virtual cards in the sub-virtual card set based on the remaining time slice and the weight of the virtual cards in the sub-virtual card set, avoiding waste of the computing power resource of the accelerator card, while guaranteeing priority execution of tasks in the high-priority virtual card.

Step 303, performing a scheduling operation on the virtual card set.

In the present embodiment, implementation details and technical effects of step 303 may be referred to the description of step 103, detailed description thereof will be omitted.

As can be seen from FIG. 3, compared to the embodiment corresponding to FIG. 1, the flow 300 of the method for scheduling a time slice in the present embodiment embodies determining, in response to determining that there is no high-priority virtual card in the virtual card set, time slices corresponding to virtual cards in the virtual card set based on the scheduling period and the weights of the virtual cards, i.e., embodies effective scheduling of a time slice under the condition of taking into account the priorities of the virtual cards, and improves the reliability and effectiveness of time-slice scheduling.

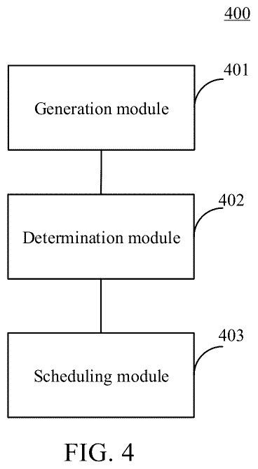

With further reference to FIG. 4, as an implementation of the method shown in the above figures, an embodiment of the present disclosure provides an apparatus for scheduling a time slice, and the apparatus embodiment corresponds to the method embodiment shown in FIG. 1, the apparatus may be applied to various electronic devices.

As shown in FIG. 4, an apparatus 400 for scheduling a time slice in the present embodiment includes: a generation module 401, a determination module 402, and a scheduling module 403.

The generation module 401 may be configured to determine a scheduling period based on the number of virtual cards in a virtual card set and a maximum scheduling delay.

The determination module 402 may be configured to determine, based on the scheduling period, time slices corresponding to the virtual cards in the virtual card set.

The scheduling module 403 may be configured to perform a scheduling operation on the virtual card set.

In some alternative implementations of the present embodiment, the determination module is further configured to: determine, in response to determining that there is no high-priority virtual card in the virtual card set, time slices corresponding to virtual cards in the virtual card set based on the scheduling period and weights of the virtual cards.

In some alternative implementations of the present embodiment, the determination module is further configured to: allocate, in response to determining that there is a high-priority virtual card in the virtual card set, the scheduling period to the high-priority virtual card; in response to determining that a load of the high-priority virtual card is empty and that there is a remaining time slice in the scheduling period; and determine, based on the remaining time slice and weights of the virtual cards in a sub-virtual card set, time slices corresponding to the virtual cards in the sub-virtual card set.

In some alternative implementations of the present embodiment, the scheduling module is further configured to: in response to determining that there is a designated virtual card having a non-empty load and no corresponding time slice allocated in the virtual card set, determine a target virtual card in the designated virtual card and allocate a corresponding time slice to the target virtual card; and in response to determining that a load of the target virtual card is empty, continuing to perform the scheduling operation before the time slice corresponding to the target virtual card runs out.

In some alternative implementations of the present embodiment, the scheduling module is further configured to: in response to determining that there is a designated virtual card having a non-empty load and no corresponding time slice allocated in the virtual card set, determine a target virtual card in the designated virtual card and allocate a corresponding time slice to the target virtual card; and continue to perform the scheduling operation, in response to determining that the time slice corresponding to the target virtual card runs out.

According to an embodiment of the present disclosure, also provides an electronic device and a readable storage medium.

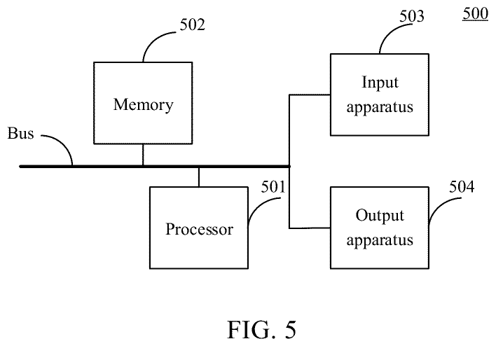

As shown in FIG. 5, is a block diagram of an electronic device of the method for scheduling a time slice according to embodiments of the present disclosure.

500 is the block diagram of the electronic device of the method for scheduling a time slice according to embodiments of the present disclosure. The electronic device is intended to represent various forms of digital computers, such as a laptop, a desktop computer, a workbench, a personal digital assistant, a server, a blade server, a mainframe computer, and other suitable computers. The electronic device may also represent various forms of mobile apparatuses, such as a personal digital assistant, a cellular phone, a smart phone, a wearable device, and other similar computing apparatuses. The components shown herein, the connections and relationships thereof, and the functions thereof are used as examples only, and are not intended to limit implementations of the present disclosure described and/or claimed herein.

As shown in FIG. 5, the electronic device includes: one or more processors 501, a memory 502, and interfaces for connecting various components, including high-speed interfaces and low-speed interfaces. The various components are connected to each other using different buses, and may be installed on a common motherboard or in other methods as needed. The processor may process instructions executed within the electronic device, including instructions stored in or on the memory to display graphic information of GUI on an external input/output apparatus (such as a display device coupled to the interface). In other embodiments, a plurality of processors and/or a plurality of buses may be used together with a plurality of memories if desired. Similarly, a plurality of electronic devices may be connected, and the devices provide some necessary operations (for example, as a server array, a set of blade servers, or a multi-processor system). In FIG. 5, one processor 501 is used as an example.

The memory 502 is a non-transitory computer readable storage medium provided by embodiments of the present disclosure. The memory stores instructions executable by at least one processor, so that the at least one processor performs the method for scheduling a time slice provided by embodiments of the present disclosure. The non-transitory computer readable storage medium described in embodiments of the present disclosure stores computer instructions for causing a computer to perform the method for scheduling a time slice provided by embodiments of the present disclosure.

The memory 502, as a non-transitory computer readable storage medium, may be used to store non-transitory software programs, non-transitory computer executable programs and modules, such as program instructions/modules corresponding to the method for scheduling a time slice in embodiments of the present disclosure (for example, the generation module 401, the determination module 402, and the scheduling module 403 shown in FIG. 4). The processor 501 executes the non-transitory software programs, instructions, and modules stored in the memory 502 to execute various functional applications and data processing of the server, that is, to implement the method for scheduling a time slice in the foregoing method embodiment.

The memory 502 may include a storage program area and a storage data area, where the storage program area may store an operating system and at least one function required application program; and the storage data area may store data created by the use of the electronic device according to the method for scheduling a time slice, etc. In addition, the memory 502 may include a high-speed random access memory, and may also include a non-transitory memory, such as at least one magnetic disk storage device, a flash memory device, or other non-transitory solid-state storage devices. In some embodiments, the memory 502 may optionally include memories remotely provided with respect to the processor 501, and these remote memories may be connected to the electronic device of the method for scheduling a time slice through a network. Examples of the above network include but are not limited to the Internet, intranet, local area network, mobile communication network, and combinations thereof.

The electronic device of the method for scheduling a time slice may further include: an input apparatus 503 and an output apparatus 504. The processor 501, the memory 502, the input apparatus 503, and the output apparatus 504 may be connected through a bus or in other methods. In FIG. 5, connection through a bus is used as an example.

The input apparatus 503 may receive input digital or character information, such as touch screen, keypad, mouse, trackpad, touchpad, pointing stick, one or more mouse buttons, trackball, joystick and other input apparatuses. The output apparatus 504 may include a display device, an auxiliary lighting apparatus (for example, LED), a tactile feedback apparatus (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, dedicated ASICs (application specific integrated circuits), computer hardware, firmware, software, and/or combinations thereof. These various embodiments may include: being implemented in one or more computer programs that can be executed and/or interpreted on a programmable system that includes at least one programmable processor. The programmable processor may be a dedicated or general-purpose programmable processor, and may receive data and instructions from a storage system, at least one input apparatus, and at least one output apparatus, and transmit the data and instructions to the storage system, the at least one input apparatus, and the at least one output apparatus.

These computing programs (also referred to as programs, software, software applications, or codes) include machine instructions of the programmable processor and may use high-level processes and/or object-oriented programming languages, and/or assembly/machine languages to implement these computing programs. As used herein, the terms “machine readable medium” and “computer readable medium” refer to any computer program product, device, and/or apparatus (for example, magnetic disk, optical disk, memory, programmable logic apparatus (PLD)) used to provide machine instructions and/or data to the programmable processor, including machine readable medium that receives machine instructions as machine readable signals. The term “machine readable signal” refers to any signal used to provide machine instructions and/or data to the programmable processor.

In order to provide interaction with a user, the systems and technologies described herein may be implemented on a computer, the computer has: a display apparatus for displaying information to the user (for example, CRT (cathode ray tube) or LCD (liquid crystal display) monitor); and a keyboard and a pointing apparatus (for example, mouse or trackball), and the user may use the keyboard and the pointing apparatus to provide input to the computer. Other types of apparatuses may also be used to provide interaction with the user; for example, feedback provided to the user may be any form of sensory feedback (for example, visual feedback, auditory feedback, or tactile feedback); and any form (including acoustic input, voice input, or tactile input) may be used to receive input from the user.

The systems and technologies described herein may be implemented in a computing system that includes backend components (e.g., as a data server), or a computing system that includes middleware components (e.g., application server), or a computing system that includes frontend components (for example, a user computer having a graphical user interface or a web browser, through which the user may interact with the implementations of the systems and the technologies described herein), or a computing system that includes any combination of such backend components, middleware components, or frontend components. The components of the system may be interconnected by any form or medium of digital data communication (e.g., communication network). Examples of the communication network include: local area networks (LAN), wide area networks (WAN), the Internet, and blockchain networks.

The computer system may include a client and a server. The client and the server are generally far from each other and usually interact through the communication network. The relationship between the client and the server is generated by computer programs that run on the corresponding computer and have a client-server relationship with each other.

According to the technical solution of the embodiments of the present application, the effectiveness of time-slice scheduling is improved.

It should be understood that the various forms of processes shown above may be used to reorder, add, or delete steps. For example, the steps described in embodiments of the present disclosure may be performed in parallel, sequentially, or in different orders. As long as the desired results of the technical solution disclosed in embodiments of the present disclosure can be achieved, no limitation is made herein.

The above specific embodiments do not constitute limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for scheduling a time slice, comprising:
determining a scheduling period based on a number of virtual cards in a virtual card set and a maximum scheduling delay;
determining, based on the scheduling period, time slices corresponding to the virtual cards in the virtual card set, a time slice being used to indicate a duration of using an external computing power resource by a virtual card; and
performing a scheduling operation on the virtual card set, the scheduling operation comprising: ending the scheduling period, in response to determining that there is no designated virtual card having a non-empty load and no corresponding time slice allocated in the virtual card set.

2. The method according to claim 1, wherein, the determining, based on the scheduling period, time slices corresponding to virtual cards in the virtual card set, comprises:
determining, in response to determining that there is no high-priority virtual card in the virtual card set, the time slices corresponding to the virtual cards in the virtual card set based on the scheduling period and weights of the virtual cards.

3. The method according to claim 2, wherein, the determining, based on the scheduling period, time slices corresponding to virtual cards in the virtual card set, comprises:
allocating, in response to determining that there is a high-priority virtual card in the virtual card set, the scheduling period to the high-priority virtual card; and
in response to determining that a load of the high-priority virtual card is empty and that there is a remaining time slice in the scheduling period, determining, based on the remaining time slice and weights of virtual cards in a sub-virtual card set, a time slice corresponding to a virtual card in the sub-virtual card set, wherein the sub-virtual card set is composed of non-high-priority virtual cards in the virtual card set.

4. The method according to claim 1, wherein, the scheduling operation further comprises:
in response to determining that in the virtual card set there is a designated virtual card having a non-empty load and no corresponding time slice allocated, determining a target virtual card in the designated virtual card and allocating a corresponding time slice to the target virtual card; and
in response to determining that a load of the target virtual card is empty, continuing to perform the scheduling operation before the time slice corresponding to the target virtual card runs out.

5. The method according to claim 1, wherein, the scheduling operation further comprises:
in response to determining that in the virtual card set there is a designated virtual card having a non-empty load and no corresponding time slice allocated, determining a target virtual card in the designated virtual card and allocating a corresponding time slice to the target virtual card; and
continuing to perform the scheduling operation, in response to determining that the time slice corresponding to the target virtual card runs out.

6. An apparatus for scheduling a time slice, comprising:
at least one processor; and
a memory, communicating with the at least one processor, wherein the memory stores instructions executable by the at least one processor, and the instructions, when executed by the at least one processor, enable the at least one processor to perform operations, the operations comprising:
determining a scheduling period based on a number of virtual cards in a virtual card set and a maximum scheduling delay;
determining, based on the scheduling period, time slices corresponding to the virtual cards in the virtual card set, a time slice being used to indicate a duration of using an external computing power resource by a virtual card; and
performing a scheduling operation on the virtual card set, the scheduling operation comprising: ending the scheduling period, in response to determining that there is no designated virtual card having a non-empty load and no corresponding time slice allocated in the virtual card set.

7. The apparatus according to claim 6, wherein, the determining, based on the scheduling period, time slices corresponding to virtual cards in the virtual card set, comprises:
determining, in response to determining that there is no high-priority virtual card in the virtual card set, the time slices corresponding to the virtual cards in the virtual card set based on the scheduling period and weights of the virtual cards.

8. The apparatus according to claim 7, wherein, the determining, based on the scheduling period, time slices corresponding to virtual cards in the virtual card set, comprises:
allocating, in response to determining that there is a high-priority virtual card in the virtual card set, the scheduling period to the high-priority virtual card; and
in response to determining that a load of the high-priority virtual card is empty and that there is a remaining time slice in the scheduling period, determine, based on the remaining time slice and weights of virtual cards in a sub-virtual card set, a time slice corresponding to a virtual card in the sub-virtual card set, wherein the sub-virtual card set is composed of non-high-priority virtual cards in the virtual card set.

9. The apparatus according to claim 7, wherein, the scheduling operation further comprises:
in response to determining that in the virtual card set there is a designated virtual card having a non-empty load and no corresponding time slice allocated, determining a target virtual card in the designated virtual card and allocating a corresponding time slice to the target virtual card; and
in response to determining that a load of the target virtual card is empty, continuing to perform the scheduling operation before the time slice corresponding to the target virtual card runs out.

10. The apparatus according to claim 7, wherein, the scheduling operation further comprises:
in response to determining that in the virtual card set there is a designated virtual card having a non-empty load and no corresponding time slice allocated, determining a target virtual card in the designated virtual card and allocating a corresponding time slice to the target virtual card; and
continuing to perform the scheduling operation, in response to determining that the time slice corresponding to the target virtual card runs out.

11. A non-transitory computer readable storage medium, storing a computer instruction thereon, wherein, the computer instruction is used to cause the computer to perform operations, the operations comprising:
determining a scheduling period based on a number of virtual cards in a virtual card set and a maximum scheduling delay;
determining, based on the scheduling period, time slices corresponding to the virtual cards in the virtual card set, a time slice being used to indicate a duration of using an external computing power resource by a virtual card; and
performing a scheduling operation on the virtual card set, the scheduling operation comprising: ending the scheduling period, in response to determining that there is no designated virtual card having a non-empty load and no corresponding time slice allocated in the virtual card set.

12. The non-transitory computer readable storage medium according to claim 11, wherein, the determining, based on the scheduling period, time slices corresponding to virtual cards in the virtual card set, comprises:
determining, in response to determining that there is no high-priority virtual card in the virtual card set, the time slices corresponding to the virtual cards in the virtual card set based on the scheduling period and weights of the virtual cards.

13. The non-transitory computer readable storage medium according to claim 12, wherein, the determining, based on the scheduling period, time slices corresponding to virtual cards in the virtual card set, comprises:
allocating, in response to determining that there is a high-priority virtual card in the virtual card set, the scheduling period to the high-priority virtual card; and
in response to determining that a load of the high-priority virtual card is empty and that there is a remaining time slice in the scheduling period, determining, based on the remaining time slice and weights of virtual cards in a sub-virtual card set, a time slice corresponding to a virtual card in the sub-virtual card set, wherein the sub-virtual card set is composed of non-high-priority virtual cards in the virtual card set.

14. The non-transitory computer readable storage medium according to claim 11, wherein, the scheduling operation further comprises:
in response to determining that in the virtual card set there is a designated virtual card having a non-empty load and no corresponding time slice allocated, determining a target virtual card in the designated virtual card and allocating a corresponding time slice to the target virtual card; and
in response to determining that a load of the target virtual card is empty, continuing to perform the scheduling operation before the time slice corresponding to the target virtual card runs out.

15. The non-transitory computer readable storage medium according to claim 11, wherein, the scheduling operation further comprises:
in response to determining that in the virtual card set there is a designated virtual card having a non-empty load and no corresponding time slice allocated, determining a target virtual card in the designated virtual card and allocating a corresponding time slice to the target virtual card; and
continuing to perform the scheduling operation, in response to determining that the time slice corresponding to the target virtual card runs out.
